(19) United States
(12) Patent Application Publication
(10) Pub. No.: US 2026/0213395 A1
(43) Pub. Date: Jul. 23, 2026

(54) EYEGLASSES DEVICE

(71) Applicant: PEGATRON CORPORATION, TAIPEI CITY (TW)

(72) Inventors: Tzu-Hao Huang, Taipei City (TW); Po-Yen Lai, Taipei City (TW); Hsiao-Feng Chang, Taipei City (TW); Hao Cheng, Taipei City (TW); Ping-Hung Lu, Taipei City (TW)

(73) Assignee: PEGATRON CORPORATION, TAIPEI CITY (TW)

(21) Appl. No.: 19/394,606

(22) Filed: Nov. 19, 2025

(30) Foreign Application Priority Data
Jan. 22, 2025 (TW) 114102857

(51) Int. Cl. H01Q 1/27; G02C 5/14; G02C 11/00; G06F 1/16

(52) U.S. Cl. CPC H01Q 1/273; G02C 5/14; G02C 11/10; G06F 1/163

(57) ABSTRACT

An eyeglasses device includes a frame, a first temple, a circuit board, and a flexible circuit board. The frame includes first and second metal parts and an insulating component connecting the first and second metal parts. Second metal part is insulated from first metal part by insulating component. At least part of appearance of the frame is formed by the first metal part and the second metal part together. The first temple is pivotally connected to the frame. The circuit board is disposed in the first temple. The flexible circuit board is disposed on the frame and the first temple and is electrically connected to the second metal part and the circuit board. The flexible circuit board includes an antenna matching circuit. The second metal part serves as an antenna, and the antenna with the antenna matching circuit is excited at a first frequency band and a second frequency band.

### CROSS-REFERENCE TO RELATED APPLICATION

This application claims the priority benefit of Taiwan application serial no. 114102857, filed on January 22, 2025. The entirety of the above-mentioned patent application is hereby incorporated by reference herein and made a part of this specification.

### BACKGROUND

### Technical Field

The disclosure relates to an eyeglasses device and particularly relates to an eyeglasses device having an antenna.

### Related Art

Under the development of the communication industry in recent years and human demands, AR/VR head-mounted wearable devices have become popular. Under the requirements of conforming to various communication functions and miniaturization, this has created the problem of difficult antenna design. How to achieve good broadband antenna functionality while meeting small dimension requirements is the research direction in this field.

### SUMMARY

The disclosure provides an eyeglasses device, in which the antenna is a part of the frame and does not occupy or occupies very little internal space, and may have good broadband antenna functionality.

An eyeglasses device of the disclosure includes a frame, a first temple, a circuit board, and a flexible circuit board. The frame includes a first metal part, a second metal part, and an insulating component connecting the first metal part and the second metal part. The second metal part is insulated from the first metal part by the insulating component. An appearance of the frame is formed by the first metal part and the second metal part together. The first temple is pivotally connected to the frame. The circuit board is disposed in the first temple. The flexible circuit board is disposed on the frame and the first temple and is electrically connected to the second metal part and the circuit board. The flexible circuit board includes an antenna matching circuit. The second metal part serves as an antenna, and the antenna with the antenna matching circuit is excited at a first frequency band and a second frequency band.

In an embodiment of the disclosure, the insulating component is a single-piece structure, a shape of the insulating component is the same as a shape of the second metal part, and the second metal part is fixed to the insulating component.

In an embodiment of the disclosure, the insulating component includes two insulating members disposed at two ends of the second metal part.

In an embodiment of the disclosure, a length of the second metal part is in a range of 0.2 times to 0.3 times the wavelength of the first frequency band.

In an embodiment of the disclosure, the eyeglasses device further includes a metal fixing member, in which the second metal part connects to the flexible circuit board through the metal fixing member.

In an embodiment of the disclosure, the antenna matching circuit includes an inductor and a capacitor.

In an embodiment of the disclosure, the inductor is in a range of 1.0nH to 1.5nH, and the capacitor is in a range of 7pF to 10pF.

In an embodiment of the disclosure, the eyeglasses device further includes a second temple pivotally connected to the frame, and the eyeglasses device further includes at least one of an optical engine module, a battery, and a speaker, disposed in the second temple.

In an embodiment of the disclosure, the eyeglasses device further includes a lens module disposed on a nose bridge part of the frame.

In an embodiment of the disclosure, the first frequency band is 2400MHz to 2480MHz, and the second frequency band is 5150MHz to 5850MHz.

Based on the above, at least a part of the appearance of the frame is together formed by the first metal part and the second metal part of the eyeglasses device of the disclosure. The second metal part serves as the antenna, and the second metal part is insulated from the first metal part by the insulating component. Since the antenna is a part of the frame and does not occupy or occupies very little internal space, the dimension of the eyeglasses device may be reduced. In addition, since the appearance of the eyeglasses device is at least partially metal, the device has better texture. Furthermore, the circuit board is disposed in the first temple, the flexible circuit board is electrically connected to the second metal part and the circuit board, and the antenna with the antenna matching circuit of the flexible circuit board is excited at the first frequency band and the second frequency band, and may have good broadband antenna function.

### BRIEF DESCRIPTION OF THE DRAWINGS

FIG. 1 is a schematic diagram of an eyeglasses device according to an embodiment of the disclosure.

FIG. 2 is a schematic diagram of the interior of the eyeglasses device in FIG. 1.

FIG. 3 is an assembly schematic diagram of the frame, a circuit board, and a flexible circuit board of the eyeglasses device in FIG. 1.

FIG. 4 is a schematic diagram of the flexible circuit board separated from the second metal part in FIG. 3.

FIG. 5 is a schematic diagram of the insulating component separated in FIG. 4.

FIG. 6 is a schematic diagram of the antenna electrically connected to the circuit board in FIG. 1.

FIG. 7 is a frequency-S11 relationship diagram of the eyeglasses device in FIG. 1.

FIG. 8 is a frequency-antenna efficiency relationship diagram of the eyeglasses device in FIG. 1.

FIG. 9 is a partial exploded view of an eyeglasses device according to another embodiment of the disclosure.

### DESCRIPTION OF THE EMBODIMENTS

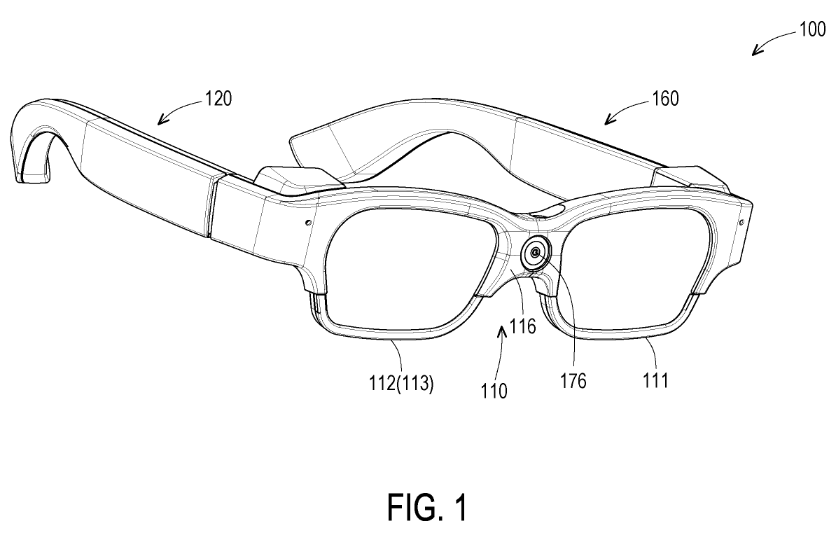

FIG. 1 is a schematic diagram of an eyeglasses device according to an embodiment of the disclosure. Referring to FIG. 1, an eyeglasses device 100 of this embodiment exemplifies AR or VR glasses, but the type of the eyeglasses device 100 is not limited thereto. The eyeglasses device 100 includes a frame 110, a first temple 120, and a second temple 160. The first temple 120 and the second temple 160 are both pivotally connected to the frame 110 and may rotate with respect to the frame 110.

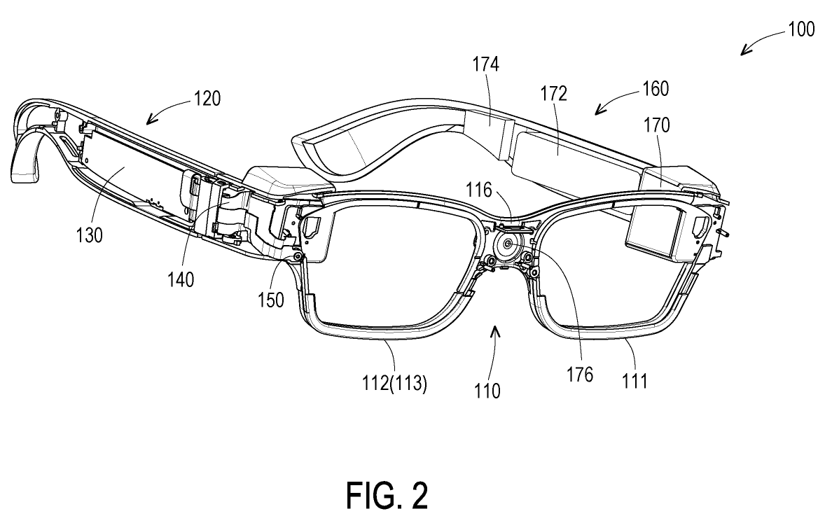

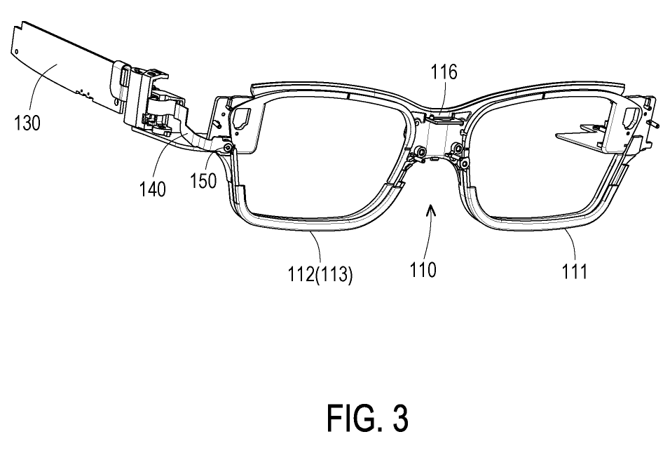

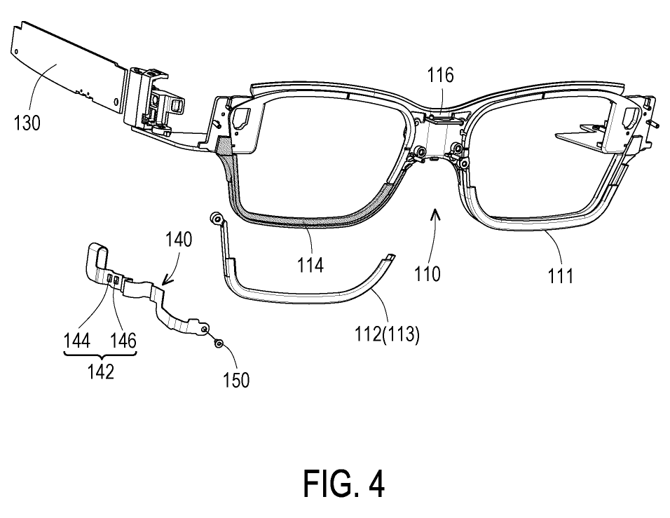

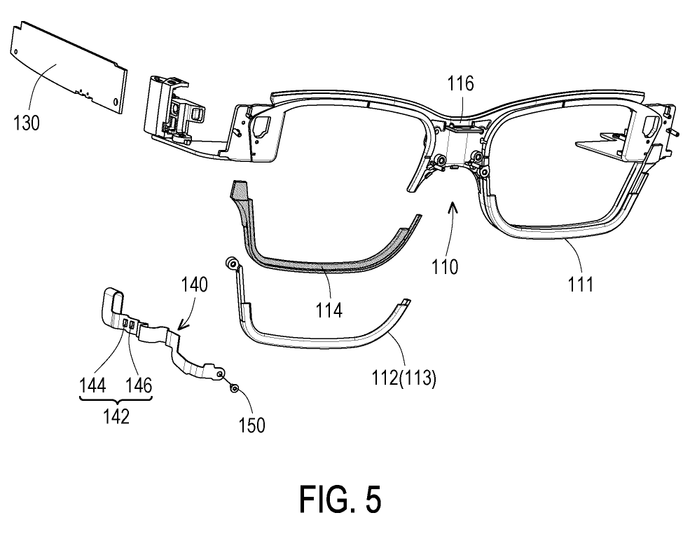

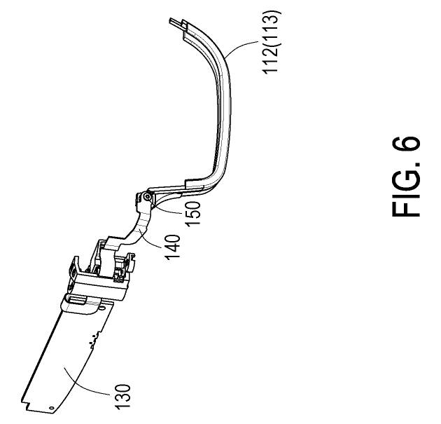

FIG. 2 is a schematic diagram of the interior of the eyeglasses device in FIG. 1. FIG. 3 is an assembly schematic diagram of the frame, a circuit board, and a flexible circuit board of the eyeglasses device in FIG. 1. FIG. 4 is a schematic diagram of the flexible circuit board being separated from the second metal part in FIG. 3. FIG. 5 is a schematic diagram of the insulating component being separated in FIG. 4. FIG. 6 is a schematic diagram of the antenna being electrically connected to the circuit board in FIG. 1.

Referring to FIG. 2 to FIG. 6, in this embodiment, the frame 110 includes a first metal part 111, a second metal part 112, and an insulating component 114 connecting the first metal part 111 and the second metal part 112.

As shown in FIG. 5, the first metal part 111 includes the frame surrounding the lens on the right side of FIG. 5, a nose bridge part 116, and the upper half of the frame surrounding the lens on the left side of FIG. 5. The insulating component 114 is the lower half of the frame surrounding the lens on the left side of FIG. 5. In this embodiment, the insulating component 114 is a single-piece structure, the shape of the insulating component 114 is the same as the shape of the second metal part 112, and the second metal part 112 is fixed to the insulating component 114.

That is, the appearance of the frame 110 is formed by the first metal part 111 and the second metal part 112 together. In addition, the second metal part 112 is insulated from the first metal part 111 by the insulating component 114 to avoid the second metal part 112 being electrically connected to the first metal part 111. The second metal part 112 serves as an antenna 113, and the first metal part 111 may be a ground plane to reduce signals that may affect the antenna 113.

The second metal part 112 of the eyeglasses device of this embodiment serves as the antenna 113. Since the antenna 113 is a part of the frame 110 and does not occupy or occupies very little internal space, the dimension of the eyeglasses device 100 may be reduced. In addition, since the appearance of the eyeglasses device 100 is at least partially metal, the device has better texture.

The materials of the first metal part 111 and the second metal part 112 may be the same or different. The insulating component 114 is, for example, plastic. The second metal part 112 and the insulating component 114 may be fabricated separately and then fixed together.

In an embodiment, the second metal part 112 and the insulating component 114 may also be fabricated through nano molding technology (NMT) method of metal and plastic. In the fabrication process of combining metal and plastic with nanotechnology, after the surface of the second metal part 112 is treated, the plastic insulating component 114 is directly injection-molded on the surface of the second metal part 112, allowing the second metal part 112 and the insulating component 114 to be integrally molded. Certainly, the fabrication method of the second metal part 112 and the insulating component 114 is not limited thereto.

In addition, as shown in FIG. 2, the eyeglasses device 100 further includes a circuit board 130, a flexible circuit board 140, and a metal fixing member 150. The circuit board 130 is disposed in the first temple 120. The flexible circuit board 140 is disposed on the frame 110 and the first temple 120, and the second metal part 112 connects to the flexible circuit board 140 through the metal fixing member 150, which allows the flexible circuit board 140 to be electrically connected to the second metal part 112 and the circuit board 130.

In other words, the antenna 113 is electrically connected to the circuit board 130 through the metal fixing member 150 and the flexible circuit board 140. In this embodiment, the metal fixing member 150 is, for example, a screw, but the type of the metal fixing member 150 is not limited thereto. The feed point of the antenna 113 may be located near the metal fixing member 150, and such design may reduce the influence of the antenna 113 signal on the face of the user.

In this embodiment, the circuit board 130 is, for example, a rigid circuit board, but the disclosure is not limited thereto. In other embodiments, the circuit board 130 may also be a flexible circuit board, or a rigid-flex board. In other embodiments, the circuit board 130 and the flexible circuit board 140 may be two separate pieces that are then electrically connected together, or may be a rigid-flex board fabricated together, and the disclosure is not limited thereto.

In addition, since the flexible circuit board 140 is thin and flexible, it may be bent at the pivot. Compared to a coaxial transmission line (not shown) that is too thick to pass through the pivot, the flexible circuit board 140 not only may provide electrical connection between the antenna 113 and the circuit board 130, but also allows the first temple 120 to rotate smoothly.

In addition, in this embodiment, the flexible circuit board 140 includes an antenna matching circuit 142. The antenna matching circuit 142 is disposed on the flexible circuit board 140, which may allow the circuit board 130 to provide more space for the configuration of other components.

The antenna 113 with the antenna matching circuit 142 is excited at a first frequency band and a second frequency band. In this embodiment, the first frequency band is 2400MHz to 2480MHz, and the second frequency band is 5150MHz to 5850MHz. The length of the second metal part 112 is in a range of 0.2 times to 0.3 times the wavelength of the first frequency band, for example, 0.25 times the wavelength. The length of the second metal part 112 is, for example, 30 millimeters, but the disclosure is not limited thereto.

Since the length of the second metal part 112 may be affected by the dimension of the frame 110, in this embodiment, the impedance of the antenna 113 (the second metal part 112) is matched by the antenna matching circuit 142 to resonate at the frequency bands of interest better.

Specifically, in this embodiment, the antenna matching circuit 142 includes an inductor 144 and a capacitor 146. In an embodiment, the antenna 113 is connected to an RF circuit (not shown) through the antenna matching circuit 142. Specifically, the capacitor 146 is disposed between the antenna 113 and the RF circuit. One end of the capacitor 146 is grounded, and the inductor 144 may be connected to another end of the capacitor 146. In an embodiment, the inductor 144 is in a range of 1.0nH to 1.5nH, for example, 1.1nH. The capacitor 146 is in a range of 7pF to 10pF, for example, 8.2pF. Certainly, the type of the antenna matching circuit 142 and the ranges of the first frequency band and the second frequency band are not limited thereto.

In this embodiment, the eyeglasses device 100 further includes at least one of an optical engine module 170, a battery 172, and a speaker 174, disposed in the second temple 160. As shown in FIG. 2, the optical engine module 170, the battery 172, and the speaker 174 are disposed in the second temple 160, with the optical engine module 170 being close to the frame 110, and the speaker 174 being close to the ear of the user. In addition, the eyeglasses device 100 further includes a lens module 176 disposed on the nose bridge part 116 of the frame 110.

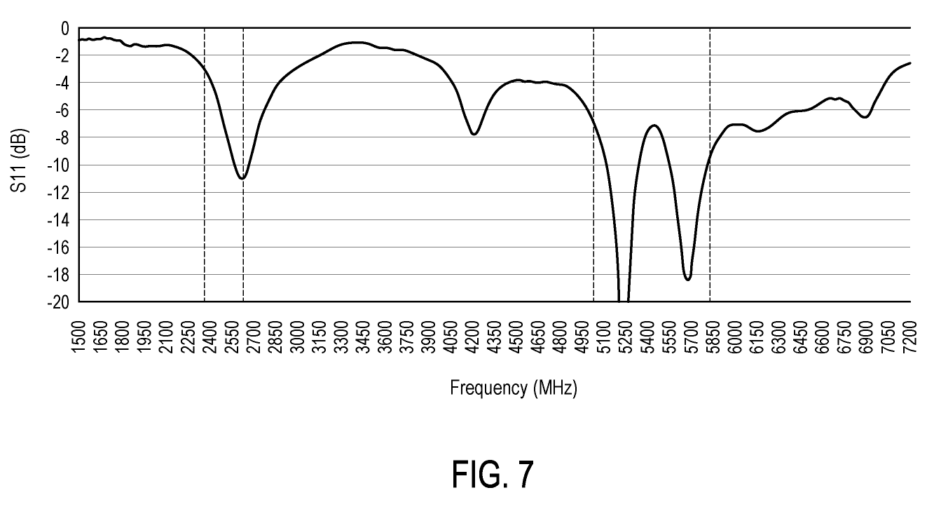

FIG. 7 is a frequency-S11 relationship diagram of the eyeglasses device in FIG. 1. Referring to FIG. 7, in this embodiment, both the first frequency band (2400MHz to 2480MHz) and the second frequency band (5150MHz to 5850MHz) have good S11 performance. Therefore, the operating frequency of the antenna 113 may cover the frequency bands of BT2.4G (2402MHz to 2480MHz) and Wi-Fi 2.4G/5G (2400MHz to 2480MHz and 5150MHz to 5850MHz).

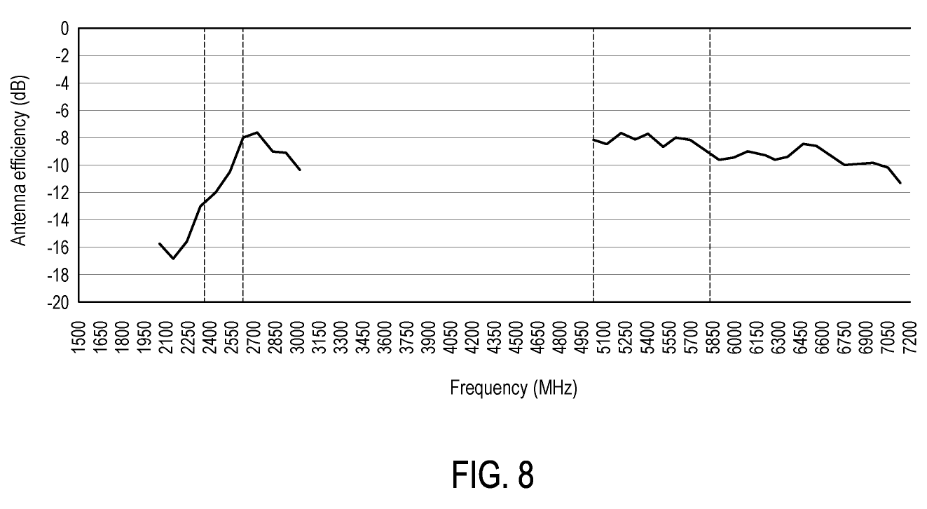

FIG. 8 is a frequency-antenna efficiency relationship diagram of the eyeglasses device in FIG. 1. Referring to FIG. 8, in this embodiment, the antenna efficiency of the antenna 113 in both the first frequency band (2400MHz to 2480MHz) and the second frequency band (5150MHz to 5850MHz) is within -13dB, both having good performance, and may cover the frequency bands of BT2.4G (2402MHz to 2480MHz) and Wi-Fi 2.4G/5G (2400MHz to 2480MHz and 5150MHz to 5850MHz).

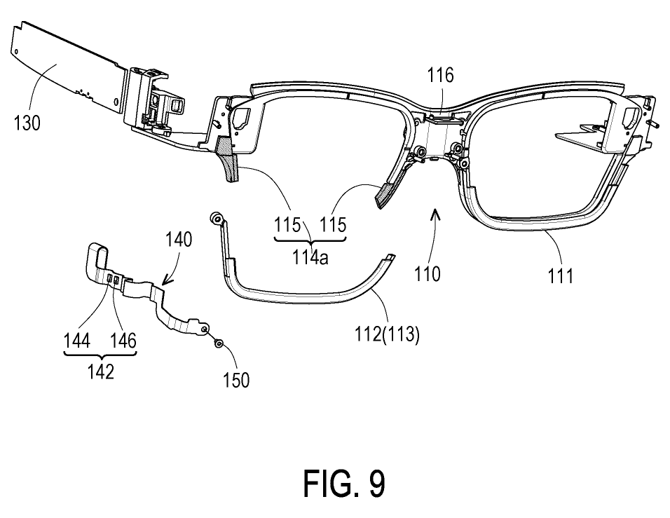

FIG. 9 is a partial exploded view of an eyeglasses device according to another embodiment of the disclosure. Referring to FIG. 9, the main difference from the eyeglasses device 100 in FIG. 5 is that, in this embodiment, an insulating component 114a includes two insulating members 115 disposed at two ends of the second metal part 112, with the two insulating members 115 separated from each other. The second metal part 112 connects to the two insulating members 115, and the first metal part 111 and the second metal part 112 are separated by the two insulating members 115.

Similarly, the second metal part 112 of the eyeglasses device of this embodiment serves as the antenna 113. Since the antenna 113 is a part of the frame 110 and does not occupy or occupies very little internal space, the dimension of the eyeglasses device may be reduced. In addition, since the appearance of the eyeglasses device is at least partially metal, the device has better texture. Furthermore, the antenna 113 with the antenna matching circuit 142 of the flexible circuit board 140 is excited at the first frequency band and the second frequency band, and may have good broadband antenna function.

In summary, at least a part of the appearance of the frame is together formed by the first metal part and the second metal part of the eyeglasses device of the disclosure. The second metal part serves as the antenna, and the second metal part is insulated from the first metal part by the insulating component. Since the antenna is a part of the frame and does not occupy or occupies very little internal space, the dimension of the eyeglasses device may be reduced. In addition, since the appearance of the eyeglasses device is at least partially metal, the device has better texture. Furthermore, the circuit board is disposed in the first temple, the flexible circuit board is electrically connected to the second metal part and the circuit board, and the antenna with the antenna matching circuit of the flexible circuit board is excited at the first frequency band and the second frequency band, and may have good broadband antenna function.

What is claimed is:

1. An eyeglasses device, comprising:
a frame comprising a first metal part, a second metal part, and an insulating component connecting the first metal part and the second metal part, wherein the second metal part is insulated from the first metal part by the insulating component, and at least a part of an appearance of the frame is formed by the first metal part and the second metal part together;
a first temple pivotally connected to the frame;
a circuit board disposed in the first temple; and
a flexible circuit board disposed on the frame and the first temple, and electrically connected to the second metal part and the circuit board, wherein the flexible circuit board comprises an antenna matching circuit, wherein
the second metal part serves as an antenna, and the antenna with the antenna matching circuit is excited at a first frequency band and a second frequency band.

2. The eyeglasses device as claimed in claim 1, wherein the insulating component is a single-piece structure, a shape of the insulating component is same as a shape of the second metal part, and the second metal part is fixed to the insulating component.

3. The eyeglasses device as claimed in claim 1, wherein the insulating component comprises two insulating members disposed at two ends of the second metal part.

4. The eyeglasses device as claimed in claim 1, wherein a length of the second metal part is in a range of 0.2 times to 0.3 times wavelength of the first frequency band.

5. The eyeglasses device as claimed in claim 1, further comprising a metal fixing member, wherein the second metal part connects to the flexible circuit board through the metal fixing member.

6. The eyeglasses device as claimed in claim 1, wherein the antenna matching circuit comprises an inductor and a capacitor.

7. The eyeglasses device as claimed in claim 6, wherein the inductor is in a range of 1.0nH to 1.5nH, and the capacitor is in a range of 7pF to 10pF.

8. The eyeglasses device as claimed in claim 1, further comprising a second temple pivotally connected to the frame, wherein the eyeglasses device further comprises at least one of an optical engine module, a battery, and a speaker, disposed in the second temple.

9. The eyeglasses device as claimed in claim 1, further comprising a lens module disposed on a nose bridge part of the frame.

10. The eyeglasses device as claimed in claim 1, wherein the first frequency band is 2400MHz to 2480MHz, and the second frequency band is 5150MHz to 5850MHz.
